(19) United States
(12) Patent Application Publication
(10) Pub. No.: US 2016/0160155 A1
(43) Pub. Date: Jun. 9, 2016

(54) CONCENTRATED HARD SURFACE CLEANER WITH READILY BIODEGRADABLE CLEANING AGENTS

(71) Applicant: Karla Call, Arvada, CO (US)

(72) Inventor: Karla Call, Arvada, CO (US)

(21) Appl. No.: 14/964,393

(22) Filed: Dec. 9, 2015

Related U.S. Application Data
(60) Provisional application No. 62/089,733, filed on Dec. 9, 2014.

(51) Int. Cl. C11D 1/66; C11D 3/22; C11D 3/382; C11D 1/90; C11D 3/20

(52) U.S. Cl. CPC C11D 1/662; C11D 1/90; C11D 3/2086; C11D 3/382; C11D 3/222

(57) ABSTRACT

An aqueous concentrated hard surface cleaning composition includes an alkyl polyglucoside, a readily biodegradable amphoteric surfactant, an acid, a gum based thickener, an essential oil, water, and one or more of dyes, colorants and preservatives.

### CROSS-REFERENCE TO RELATED APPLICATION

This application claims the benefit of the filing date of U.S. Provisional Application No. 62/089,733, filed Dec. 9, 2014, and entitled CONCENTRATED HARD SURFACE CLEANER WITH READILY BIODEGRADABLE CLEANING AGENTS, the disclosure of which is incorporated, in its entirety, by reference.

### TECHNICAL FIELD

The present disclosure relates to concentrated hard surface cleaners especially effective on soils, such as soap scum.

### BACKGROUND

Concentrated hard surface cleaning solutions are an environmentally friendly approach to home care as they give consumers the opportunity to refill their own bottles. This cuts down on the amount of plastic and paper used for packaging and allows the percentage of concentrate to change for various household chores.

A number of concentrated hard surface cleaners have been formulated to target bathroom soils. These include products containing liquid hypochlorite for combating mildew and fungus, products with quaternary ammonium compounds as bacteriostats, and acid cleaners, such as those containing phosphoric or other strong mineral acids. While these products are effective at removing bathroom soils, they require cautious use and can be hazardous to the skin, eyes and respiratory system, as well as the environment.

Readily biodegradable products are the preferred choice for environmental and human health, but often do not clean as well. Finding a readily biodegradable combination of agents and surfactants that work as well as their non-green counterparts may be beneficial to cleanliness and health.

### SUMMARY

An aqueous hard surface cleaning composition, which includes: at least one nonionic surfactant, an acid, an essential oil, water and optionally, a readily biodegradable amphoteric, a gum based thickener and dyes, colorants and preservatives.

The at least one nonionic surfactant may be provided in an amount of about 20% wt. to about 45% wt. The organic acid may be provided in an amount of about 25% wt. to about 45% wt. The essential oil may be provided in an amount of about 0.005% wt. to about 1% wt. The biodegradable amphoteric surfactant may be provided in an amount of about 15% wt. to about 30% wt. The gum based thickener may be provided in an amount of about 0.20% wt. to about 0.80% wt. The water may include at least one of distilled water or deionized water, and the water may be provided in an amount of about 15% wt. to about 30% wt. The dyes, colorants, and preservatives may be natural dyes, colorants, and preservatives. A ph level of the composition may be between about 1 and about 2.5. The nonionic surfactant may include a glucoside from the group consisting of is caprylyl/capryl glucoside, caprylyl/myristyl glucoside and combinations thereof. The organic acid may include citric acid. The essential oil may include menthe piperitae. The biodegradable amphoteric surfactant may include cocamidopropyl betaine. The cleaning composition may be diluted with water for various cleaning purposes. The cleaning composition may be diluted with water and used inside a cleaning tool or device.

Another aspect of the present disclosure relates to an aqueous hard surface cleaning composition that includes a nonionic surfactant, an acid, an essential oil, water, and one or more of a readily biodegradable amphoteric surfactant, a gum based thickener, dyes, colorants, and preservatives.

The at least one nonionic surfactant may be provided in an amount of about 20% wt. to about 45% wt. The organic acid may be provided in an amount of about 25% wt. to about 45% wt. The essential oil may be provided in an amount of about 0.005% wt. to about 1% wt. The water may include at least one of distilled water or deionized water, and the water may be provided in an amount of about 15% wt. to about 30% wt.

The foregoing and other features, utilities, and advantages of the subject matter described herein will be apparent from the following more particular description of certain embodiments as illustrated in the accompanying figures.

### DETAILED DESCRIPTION

The present disclosure is directed to a concentrated hard surface cleaning composition, which has been shown to work at least as well as several popular non-green counterparts and typically requires less cleaning solution per use.

One aspect of the present disclosure relates to a concentrated hard surface cleaning composition that includes an alkyl polyglucoside, an acid, an essential oil, and water.

Another aspect of the present disclosure relates to a concentrated hard surface cleaning composition that includes an alkyl polyglucoside, a readily biodegradable amphoteric, an acid, an essential oil, a gum based thickener, water, and optionally at least one of dyes, colorants, and preservatives.

In one example, the cleaning solution includes alkyl polyglucoside, which is a nonionic surfactant compatible with all other surfactant classes. The alkyl polyglucoside or glucoside combinations may include at least one of the following: decyl glucoside, capryl/caprylyl glucoside, myristyl glucoside, coco glucoside, caprylyl/myristyl glucoside and lauryl glucoside. More preferred of the alkyl polyglucosides is caprylyl/capryl glucoside and caprylyl/myristyl glucoside. Particularly preferred amongst the alkyl polyglucosides is caprylyl/myristyl glucoside. This nonionic surfactant may be present in an amount of about 5.5% to about 50% wt., more preferably in an amount of about 10% to about 45% wt., and most preferably in an amount of about 20% to about 45% wt. The alkyl polyglucosides selected according to the present disclosure have improved wetting, penetration and detergency properties and may also provide non-streaking and non-filming benefits.

An example cleaning solution may include an acid constituent such as a water-soluble inorganic acid, or a water-soluble organic acid. Some example acid constituents include water-soluble organic acids such as, for example, lactic acid, acetic acid, formic acid, citric acid, oxalic acid, uric acid, malic acid, sorbic acid and glycolic acid. Citric and glycolic acids may be preferred amongst these organic acids, with citric acid typically being the most preferred.

The compositions disclosed herein are necessarily acidic in nature. As such, there is typically sufficient acid present in the composition so that the pH of the composition is desirably less than about 5, preferably from about 1 to about 3.5, more preferably from about 1 to about 2.5, and most preferably from about 1 to about 2. The percentage acid present in the composition may be in any amount, but typically not in excess of about 60%, preferably from about 20% to about 50% more preferably from about 25% to about 45%, and most preferably from about 30% to about 40%.

The acid constituent in the compositions disclosure herein may provide free acidity within the cleaning composition. The acidity may react with the fatty acid metal salts comprised within soap scum stains and releases the metal ions to free the fatty acid, which facilitates the removal of these undesired stains from hard surfaces. These acids also sequester the resulting free metal ions, which are released from the soap scum stains. Also, where the acids are selected to feature disinfecting properties, the acids concomitantly provide anti-microbial activity necessary to disinfect the cleaned surface.

The compositions disclosed herein may contain an amphoteric surfactant. An example amphoteric is from the zwitterionic class including, for example, amphiphile, CHAPS detergent, cocamidopropyl betaine, cocamidopropyl hydroxysultaine, egg lecithin, hydroxysultaine, lecithin, and sodium lauroamphoacetate. More preferred among the zwitterionic class is cocamidopropyl betaine and cocamidopropyl hydroxysultaine. Particularly preferred amongst the zwitterionics is cocamidopropyl betaine. The readily biodegradable amphoteric surfactant used in the disclosed compositions increases an amount of foam in the cleaning composition and therefore requires less solution to complete a cleaning task. The amphoteric surfactant present may be provided in an amount of about 1% to about 30% wt., more preferably in an amount of about 5% to about 25% wt., and most preferably in an amount of about 10% to about 20% wt.

The compositions disclosed herein may comprise a thickener constituent. Preferred are gum-based thickeners including, for example, algnin, guar gum, locust bean gum, and xantham gum. Particularly preferred is xanthum gum. Providing a thickening agent in the composition typically keeps the cleaning solution suspended on hard surfaces and is an emulsifying agent.

A weight percentage amount of thickener present in the composition may be in any amount which is effective at causing the solution to cling to hard surfaces and keep the surfactants and other cleaning agents emulsified in the solution. Generally, good thickening has been observed when the total amount of thickener present is in the amount of about 0.001% to about 1.4% wt., more preferably about 0.01% to about 0.8% wt., and most preferably in an amount of about 0.2% to about 0.8% wt. for the total amount of thickeners present in the composition.

The compositions disclosed herein may also comprise an essential oil. EP-A-912678 discloses the use of essential oil compounds for anti microbial effect on hard surfaces. The essential oil may include, for example, amyl salicylate, carvacrol, cymme, e.g. p-cymene, dihydroeugenol, eugenol, hexyl eugenol, hexyl salicylate, isoeugenol, methyl eugenol, methyl isoeugenol, methyl salicylate, tert butyl cresol, thymol, vanillin, cedrene, cineole, citral, citronellal, citronellol, eucalyptol, paradihydrolinalool, dihydromyrcenol, farnesol, geraniol, hexyl cinnamaldehyde, mentha piperitae, hydroxycitronallol, hydroxycitronellal, isocitral, limonene, d-limonene, linalool, longifolene, menthol, nerol, nerolidiol, pinene, a-pinene, phellendrene, terpinene, terpinool, and tetrahydromyrcenol. A concentration of essential oil in the composition may be in the range of about 0.001% to about 25% wt., more preferred about 0.002% to about 15% wt., and most preferred about 0.005% to about 1% wt. of a total weight of the composition.

The compositions disclosed herein may comprise at least one of dyes, colorants and preservatives. Thee cleaning compositions optionally contain at least one of dyes, colorants and preservatives, or contain one or more, or none of these components. These dyes, colorants and preservatives can be natural (occurring in nature or slightly processed from natural materials) or synthetic. Natural preservatives include, for example, benzyl alcohol, potassium sorbate and bisabalol, sodium benzoate and 2-phenoxyethanol. Preservatives, when used, include, but are not limited to, mildewstat or bacteriostat, methyl, ethyl and propyl parabens, short chain organic acids (e.g. acetic, lactic and/or glycolic acids), bisguanidine compounds (e.g. Dantagard and/or Glydant) and/or short chain alcohols (e.g. ethanol and/or IPA). The mildewstat or bacteriostat includes, but is not limited to, mildewstats (including non-isothiazolone compounds) including Kathon GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL, a 2-bromo-2-nitropropane 1,3 diol, from Boots Company Ltd., PROXEL CRL, a propyl-p-hydroxybenzoate, from ICI PLC; NIPASOL M, an o-phenyl-phenol, Na⁺ salt, from Nipa Laboratories Ltd., DOWICIDE A, a 1,2-Benzoisothiazolin-3-one, from Dow Chemical Co., and IRGASAN DP 200, a 2,4,4′-trichloro-2-hydroxydiphenylether, from Ciba-Geigy A.G. Dyes and colorants include synthetic dyes such as Liquitint® Yellow or Blue or natural plant dyes or pigments, such as a natural yellow, orange, red, and/or brown pigment, such as carotenoids, including, beta-carotene and lycopene.

### Substances Generally Recognized as Safe

Compositions according to the present disclosure may comprise substances generally recognized as safe (GRAS), including essential oils, oleoresins (solvent-free) and natural extractives including distillates), and synthetic flavoring materials and adjuvants.

Compositions may also comprise GRAS materials commonly found in, for example, cotton, cotton textiles, paper and paperboard stock dry food packaging materials (referred herein as substrates) that have been found to migrate to dry food and, by inference may migrate into the inventive compositions when these packaging materials are used as substrates in the inventive compositions.

Suitable GRAS materials are listed in the Code of Federal Regulations (CFR) Title 21 of the United States Food and Drug Administration, Department of Health and Human Services, Parts 180.20, 180.40 and 180.50, which are hereby incorporated by reference. These suitable GRAS materials include essential oils, oleoresins (solvent-free), and natural extractives (including distillates). The GRAS materials may be present in the compositions in amounts of up to about 10% by weight, preferably in amounts of 0.01% wt. and 5% wt.

Preferred GRAS materials include oils and oleoresins (solvent-free) and natural extractives (including distillates) derived from, for example, alfalfa, allspice, almond bitter (free from prussic acid), ambergris, ambrette seed, angelica, angostura (cusparia bark), anise, apricot kernel (persic oil), asafetida, balm (lemon balm), balsam (of Peru), basil, bay leave, bay (myrcia oil), bergamot (bergamot orange), bois de rose (Aniba rosaeodora Ducke), cacao, camomile (chamomile) flowers, cananga, capsicum, caraway, cardamom seed (cardamon), carob bean, carrot, cascarilla bark, cassia bark, Castoreum, celery seed, cheery (wild bark), chervil, cinnamon bark, Civet (zibeth, zibet, zibetum), ceylon (Cinnamomum zeylanicum Nees), cinnamon (bark and leaf), citronella, citrus peels, clary (clary sage), clover, coca (decocainized), coffee, cognac oil (white and green), cola nut (kola nut), coriander, cumin (curnmin), curacao orange peel, cusparia bark, dandelion, dog grass (quackgrass, trificum), elder flowers, estragole (esdragol, esdragon, estragon, tarragon), fennel (sweet), fenugreek, galanga (galangal), geranium, ginger, grapefruit, guava, hickory bark, horehound (hoarhound), hops, horsemint, hyssop, immortelle (Helichrysum augustifolium DC), jasmine, juniper (berries), laurel berry and leaf, lavender, lemon, lemon grass, lemon peel, lime, linden flowers, locust bean, lupulin, mace, mandarin (Citrus reticulata Blanco), marjoram, mate, menthol (including menthyl acetate), molasses (extract), musk (Tonquin musk), mustard, naringin, neroli (bigarade), nutmeg, onion, orange (bitter, flowers, leaf, flowers, peel), origamum, palmarosa, paprika, parsley, peach kernel (persic oil, pepper (black, white), peanut (stearine), peppermint, Peruvian balsam, petitgrain lemon, petitgrain mandarin (or tangerine), pimenta, pimento leaf, pipsissewa leaves, pomegranate, prickly ash bark, quince seed, rose (absolute, attar, buds, flowers, fruit, hip, leaf), rose geranium, rosemary, safron, sage, St. Johns bread, savory, schinus molle (Schinus molle L), sloe berriers, spearmint, spike lavender, tamarind, tangerine, tarragon, tea (Thea sinensis L.), thyme, tuberose, turmeric, vanilla, violet (flowers, leaves), wild herry bark, ylang-ylang and zedoary bark.

Suitable synthetic flavoring substances and adjuvants are listed in the Code of Federal Regulations (CFR) Title 21 of the United States Food and Drug Administration, Department of Health and Human Services, Part 180.60, which is hereby incorporated by reference. These GRAS materials may be present in the compositions in amounts of up to about 1% by weight, and preferably in amounts of about 0.01% wt. to about 0.5% wt. Suitable synthetic flavoring substances and adjuvants that are generally recognized as Safe for their intended use, include, for example, acetaldehyde (ethanal), acetoin (acetyl methylcarbinol), anethole (parapropenyl anisole), benzaldehyde (benzoic aldehyde), n-Butyric acid (butanoic acid), d- or l-carvone (carvol), cinnamaldehyde (cinnamic aldehyde), citral (2,6-dimethyloctadien-2,6-al-8, gera-nial, neral), decanal (N-decylaldehyde, capraldehyde, capric aldehyde, caprinaldehyde, aldehyde C-10), ethyl acetate, ethyl butyrate, 3-Methyl-3-phenyl glycidic acid ethyl ester (ethyl-methyl-phenyl-glycidate, so-called strawberry aldehyde, C-16 aldehyde), ethyl vanillin, geraniol(3,7-dimethyl-2,6 and 3,6-octa.dien-1-ol), geranyl acetate (geraniol acetate), limonene (d-, 1-, and dl-), linalool (linalol, 3,7-dimethyl-1,6-octadien-3-ol), linalyl acetate (bergamol), methyl anthranilate (methyl-2-aminobenzoate), piperonal (3,4-methylenedioxy-benzaldehyde, heliotropin) and vanillin.

Suitable GRAS substances that may be present in the compositions disclosed herein that have been identified as possibly migrating to food from cotton, cotton textiles, paper and paperboard materials used in dry food packaging materials are listed in the Code of Federal Regulations (CFR) Title 21 of the United States Food and Drug Administration, Department of Health and Human Services, Parts 180.70 and 180.90, which are hereby incorporated by reference. The GRAS materials may be present in the compositions either by addition or incidentally owing to migration from the substrates to the compositions employed in the invention, or present owing to both mechanisms. If present, the GRAS materials may be present in the compositions in amounts of up to about 1% by weight.

Suitable GRAS materials that are suitable for use in the compositions disclosed herein, identified as originating from either cotton or cotton extile materials used as substrates in the invention, include, for example, beef tallow, carboxymethylcellulose, coconut oil (refined), cornstarch, gelatin, lard, lard oil, oleic acid, peanut oil, potato starch, sodium acetate, sodium chloride, sodium silicate, sodium tripolyphosphate, soybean oil (hydrogenated), talc, tallow (hydrogenated), tallow flakes, tapioca starch, tetrasodium pyrophosphate, wheat starch and zinc chloride.

Suitable GRAS materials that are suitable for use in the compositions disclosed herein, identified as originating from either paper or paperboard stock materials used as substrates in the disclosed compositions, include, for example, alum (double sulfate of aluminum and ammonium potassium, or sodium), aluminum hydroxide, aluminum oleate, aluminum palmitate, casein, cellulose acetate, cornstarch, diatomaceous earth filler, ethyl cellulose, ethyl vanillin, glycerin, oleic acid, potassium sorbate, silicon dioxides, sodium aluminate, sodium chloride, sodium hexametaphosphate, sodium hydrosulfite, sodium phospho-aluminate, sodium silicate, sodium sorbate, sodium tripolyphosphate, sorbitol, soy protein (isolated), starch (acid modified, pregelatinized and unmodified), talc, vanillin, zinc hydrosulfite and zinc sulfate.

The balance of the solution is typically water in order to provide 100% by weight of the composition. The water may be tap water, but is preferably distilled water, and is most preferably deionized water. If the water is tap water, it is preferably substantially free of any undesirable impurities such as organics or inorganics, especially mineral salts, which are present in hard water and may interfere with the operation of the constituents present in the composition of the invention.

### EXAMPLE 1

An example composition includes the following:

42.71% wt. of caprylyl/myristyl glucoside (nonionic surfactant)

38.32% wt. of citric acid (acid)

0.008% wt. of mentha piperitae (essential oil)

18.88% wt. of water

### EXAMPLE 2

An example composition includes the following:

38.32% wt. of citric acid (acid)

22.35% wt. of capryly/myristyl glucoside

19.16% wt. of cocamidopropyl betaine

0.60% wt of xantham gum (thickener)

0.008% wt. of menthe piperitae (essential oil)

19.56% wt. of water

Testing of the Example 1 composition was conducted by Microbac Laboratories. The testing results show that the example compositions disclosed herein, as represented by the Example 1 composition, while readily biodegradable, perform essentially as well as their non-green equivalents. Readily biodegradable products are typically superior in personal safety and environmental health because they do not contain liquid hypochlorite or ammonium compounds, which do not biodegrade and are known to be hazardous irritants to the skin, eyes and respiratory system. Biodegradability is a measure of the decomposition of organic matter, including foams and water enhancers, through the action of microorganisms. Products that are more biodegradable will more easily or quickly deteriorate into smaller segments which usually do not have the same characteristics. These smaller segments may, or may not, have less impact on the environment; although it is generally assumed that less complex products have less impact. The grading scale for biodegradability used by the Forest Service has three levels:
A concentrate which is ≧60% biodegraded within 28 days is considered to be readily biodegradable.
A concentrate which is not ≧60% biodegraded within 28 days but which is ≧60% biodegraded by 42 days is considered to be biodegradable.
A concentrate which is not ≧60% biodegraded by 42 days is considered to be not biodegradable.

### Example Testing Method

One part cleaning composition was mixed with 6 parts water to comprise of 32 ounces of new cleaning solution. This cleaning solution was placed in a 32 ounce spray bottle. The 32 ounce spray bottle of cleaning solution (also referred to as the “new cleaning solution” and in the charts below as “Shower Shimmy”) and one 623 gram aerosol can of Antibacterial Scrubbing Bubbles® Bathroom Cleaner made by SC Johnson were delivered by the client on Jan. 10, 2014. The Scrubbing Bubbles cleaner was selected because SC Johnson claims that Scrubbing Bubbles® is the best-selling bathroom cleaner in the United States and Canada.

The cleaning effectiveness of the new cleaning solution was evaluated against four different soils on ceramic tiles. For comparison, the same testing was also performed in the same manner using the Scrubbing Bubbles® cleaner. The four soils used were: dirt/mud, synthetic soap scum, rust, and mineral deposits. The dirt/mud soil was applied to tan colored ceramic tiles with a rough surface. The synthetic soap scum and rust soils were applied to glossy white ceramic tiles. The mineral deposit soil was applied to pieces of clear glass. All tiles were approximately 6×6 inches in size and three tiles were used for each soil and each cleaner. The glass pieces were approximately 5×7 inches and one piece was used for each cleaner.

The dirt soil was made by mixing roughly equal parts of potting soil and a clay-type soil dug from a nearby residence. This was mixed with water to create a moderately thick mud. Equal amounts of the dirt/mud soil, approximately 1 teaspoon each, were placed on the center of each tile and ground into the surface with fingers. The soil was allowed to dry and then any loose particles were lightly brushed off before testing. Six tiles were prepared.

The synthetic soap scum was prepared by mixing 9.18 grams of calcium stearate and 5.82 grams of magnesium stearate into 135 grams of isopropanol. A few drops of blue food coloring were also added to increase the visibility of the soap scum on the tiles, although the final color change was not strong. This mixture was sprayed onto the white tiles which were pre-heated to approximately 165° F. The spray was done with a Home Depot brand 32-ounce spray bottle with a fine mist and 10 strokes per tile, applied as evenly as possible. The tiles were then baked at 345° F. for one hour before removing and allowing to cool to room temperature. A total of 12 tiles were prepared in two batches of six tiles each.

The rust stain was applied by evenly spreading 0.2 grams of steel filings on top of white tiles, misting with a saltwater solution and covering the surface with plastic sheeting for several days. The plastic sheet was removed and the tiles were allowed to dry. They were then rinsed gently in tap water with light brushing to remove loose particles and salt residue, leaving numerous spots of rust stain on the tiles. Six tiles were prepared.

The mineral deposits were created on the glass by repeatedly spraying the glass with hard water obtained from a local residence with well water. The water was sprayed as evenly as possible with a Home Depot brand 32-ounce spray bottle with a fine mist. The glass pieces were allowed to dry under moving air before spraying again. Occasionally, the glass pieces were rinsed in tap water to remove soluble salt residues, leaving only the adhered minerals on the glass. Two glass pieces were prepared.

The apparatus used to perform the cleaning was a Gardner straight line washability tester. O-Cel-O™ sponges made by 3M were cut to a size of approximately 3.5×1.6 inches to fit the sponge holder of the apparatus. Each sponge piece was rinsed in tap water and the excess water squeezed out by hand before using. A new sponge surface was used for each test. The weight of the sponge holder was 324 grams.

The test procedure consisted of the following steps:

1. The tile or glass was photographed in the dirty state.

2. The tile or glass was placed horizontally and sprayed with one of the cleaners. The cleaner was sprayed evenly onto the surface to wet the entire surface and the tile or glass was then allowed to sit for 3 or 6 minutes before testing. The dirt, rust, and mineral deposit soils were all tested after a 3-minute soak period. The soap scum soil was initially tested after a 3-minute soak with one batch of tiles. The test was then was repeated using a 6-minute soak and using the second batch of tiles.

3. The tile or glass was placed in the test machine and the desired number of sponge cleaning cycles was performed (1 cycle for the dirt soil, 15 cycles for soap scum, 20 cycles for rust, and 10 cycles for mineral deposits).

4. The tile or glass was removed and gently rinsed in tap water, then dried under blowing air.

5. The tile or glass was visually inspected and photographed.

For visually evaluating the cleaned surfaces, the amount of stain removal in the scrubbed area was estimated on a scale of 1 to 5 as follows:

1. No or very little soil removed.

2. Approximately 25% of soil removed.

3. Approximately 50% of soil removed.

4. Approximately 75% of soil removed.

5. Virtually all soil removed.

Any other observations of the effectiveness of the cleaning were also recorded.

Tables 1-5 list the rating for each of the observations.

TABLE 1
Tiles Soiled With Dirt

| Cleaner | Tile | Cleaning Rating | Observations |
|---|---|---|---|
| Shower | A1 | 5 | Both cleaners removed all of |
| Shimmy | A2 | 5 | the dirt in the scrubbed area. |
| | A3 | 5 | Scrubbing bubbles removed |
| | average | 5 | more of the dirt in the un- |
| Scrubbing | B1 | 5 | scrubbed area than the |
| Bubbles | B2 | 5 | Shower Shimmy Cleaner. |
| | B3 | 5 | |
| | average | 5 | |

TABLE 2
Tiles Soiled With Synthetic Soap Scum, 3-Minute Soak Time

| Cleaner | Tile | Cleaning Rating | Observations |
|---|---|---|---|
| Shower | A1 | 3 | In general, Shower Shimmy |
| Shimmy | A2 | 3 | with a sponge scrubbing |
| | A3 | 1.5 | removed somewhat more of |
| | average | 2.5 | th soap scum, but in the un- |
| Scrubbing | B1 | 2 | scrubbed area the Scrubbing |
| Bubbles | B2 | 2 | Bubbles removed somewhat |
| | B3 | 2 | more. |
| | average | 2 | |

TABLE 3
Tiles Soiled With Synthetic Soap Scum, 6-Minute Soak Time

| Cleaner | Tile | Cleaning Rating | Observations |
|---|---|---|---|
| Shower | A4 | 5 | Shower Shimmy Cleaner |
| Shimmy | A5 | 5 | removed about 50% of the |
| | A6 | 5 | soap scum in the un-scrubbed |
| | average | 5 | area. Scrubbing Bubbles |
| Scrubbing | B4 | 5 | removed about 75% of the |
| Bubbles | B5 | 5 | soap scum in the un-scrubbed |
| | B6 | 5 | area. |
| | average | 5 | |

TABLE 4
Tiles Soiled With Rust

| Cleaner | Tile | Cleaning Rating | Observations |
|---|---|---|---|
| Shower | A1 | 3 | The two cleaners gave |
| Shimmy | A2 | 3 | essentially equivalent results; |
| | A3 | 3 | about half of the rust stain was |
| | average | 3 | removed in the scrubbed area. |
| Scrubbing | B1 | 3 | |
| Bubbles | B2 | 3 | |
| | B3 | 3 | |
| | average | 3 | |

TABLE 5
Tiles Soiled With Mineral Deposits

| Cleaner | Glass Piece | Cleaning Rating | Observations |
|---|---|---|---|
| Shower | A1 | 2 | Both cleaners removed the |
| Shimmy | | | “haze”, but left the heavier |
| Scrubbing | B1 | 2 | build-up deposits in place. |
| Bubbles | | | |

Each readily biodegradable surfactant and cleaning agent selected for use in the disclosed compositions was done so for a specific purpose. For example, the alkyl polyglucoside presents superior wetting, penetration and detergency properties in conjunction with non-streaking and non-filming benefits. The organic acid reacts with the fatty acid metal salts comprised within soap scum stains and releases the metal ions to free the fatty acid, which facilitates the removal of these undesired stains from hard surfaces. These acids also sequester the resulting free metal ions, which are released from the soap scum stains. The amphoteric surfactant selected for the disclosed compositions is an effective foam booster and viscosity builder and therefore requires less solution to complete a cleaning task. The gum-based thickener in the composition keeps the cleaning solution suspended on hard surfaces and is an emulsifying agent. The essential oil in the present invention is used for anti microbial and aromatic effect on hard surfaces. Finally, water is used to disperse the surfactants and agents in the cleaning solution.

Other than in the operating examples, or where otherwise indicated, all numbers expressing quantities of ingredients or reaction conditions used herein are to be understood as being modified in all instances by the term “about”. As used herein, weight percent (wt-%), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or cany out the methods; and the like. The term about also encompasses amounts that differ due to different equilibrium conditions for a composition resulting from a particular initial mixture. Whether or not modified by the term “about,” the claims include equivalents to the quantities.

The term “surfactant” or “surface active agent” refers to an organic chemical that when added to a liquid changes the properties of that liquid at a surface. “Cleaning” means to perform or aid in soil removal, bleaching, microbial population reduction, rinsing, or combination thereof.

As used herein, the term “substantially free” refers to compositions completely lacking the component or having such a small amount of the component that the component does not area the effectiveness of the composition. The component may be present as an impurity or as a contaminant and shall be less than 0.5 wt. %. In another embodiment, the amount of the component is less then 0.1 wt-% and in yet another embodiment, the amount of component is less than 0.01 wt. %. As used herein, the term “ware” includes items such as eating and cooking utensils. As used herein, the term “warewashing” refers to washing, cleaning, or rinsing ware. As used herein, the term “hard surface” includes showers, sinks, toilets, bathtubs, countertops, windows, mirrors, transportation vehicles, floors, and the like. These surfaces can be those typified as “hard surfaces” (such as walls, floors, bed-pans) It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

While this invention is susceptible of embodiment in many different forms, there is shown in the drawings and will herein be described in detail, a preferred embodiment with the understanding that the present disclosure should be considered as an exemplification of the principles of the invention and is not intended to limit the invention of the embodiment so illustrated.

What is claimed is:

1. An aqueous hard surface cleaning composition, comprising essentially of:
a nonionic surfactant;
an acid;
an essential oil;
a readily biodegradable amphoteric surfactant;
a gum based thickener;
water; and
one or more of dyes, colorants and preservatives.

2. The composition of claim 1, wherein the at least one nonionic surfactant is provided in an amount of about 20% wt. to about 45% wt.

3. The composition of claim 1, wherein the organic acid is provided in an amount of about 25% wt. to about 45% wt.

4. The composition of claim 1, wherein the essential oil is provided in an amount of about 0.005% wt. to about 1% wt.

5. The composition of claim 1, wherein the biodegradable amphoteric surfactant is provided in an amount of about 15% wt. to about 30% wt.

6. The composition of claim 1, wherein the gum based thickener is provided in an amount of about 0.20% wt. to about 0.80% wt.

7. The composition of claim 1, wherein the water comprises at least one of distilled water or deionized water, the water provided in an amount of about 15% wt. to about 30% wt.

8. The composition of claim 1, wherein the dyes, colorants, and preservatives are natural dyes, colorants, and preservatives.

9. The composition of claim 1, wherein a ph level of the composition is between about 1 and about 2.5.

10. The composition of claim 2, wherein the nonionic surfactant comprises a glucoside from the group consisting of is caprylyl/capryl glucoside, caprylyl/myristyl glucoside and combinations thereof.

11. The composition of claim 3, wherein the organic acid is citric acid.

12. The composition of claim 4, wherein the essential oil is menthe piperitae.

13. The composition of claim 5, wherein the biodegradable amphoteric surfactant is cocamidopropyl betaine.

14. A method of cleaning, wherein the composition of claim 1 is diluted with water for various cleaning purposes.

15. A method of cleaning, wherein the composition of claim 1 is diluted with water and used inside a cleaning tool or cleaning device.

16. An aqueous hard surface cleaning composition, comprising:
a nonionic surfactant;
an acid;
an essential oil;
water; and
one or more of:
a readily biodegradable amphoteric surfactant;
a gum based thickener;
dyes;
colorants; and
preservatives.

17. The composition of claim 16, wherein the at least one nonionic surfactant is provided in an amount of about 20% wt. to about 45% wt.

18. The composition of claim 17, wherein the organic acid is provided in an amount of about 25% wt. to about 45% wt.

19. The composition of claim 18, wherein the essential oil is provided in an amount of about 0.005% wt. to about 1% wt.

20. The composition of claim 19, wherein the water comprises at least one of distilled water or deionized water, the water provided in an amount of about 15% wt. to about 30% wt.
